(19) United States
(12) Patent Application Publication
(10) Pub. No.: US 2016/0217242 A1
(43) Pub. Date: Jul. 28, 2016

(54) System and Method of Fieldbus Vitual Device Instantiation and Simulation of Segment

(71) Applicants: Garrett Beaubien, Calgary (CA); Xiaoqiang Liu, Calgary (CA); Jia Mei, Calgary (CA)

(72) Inventors: Garrett Beaubien, Calgary (CA); Xiaoqiang Liu, Calgary (CA); Jia Mei, Calgary (CA)

(21) Appl. No.: 14/604,218

(22) Filed: Jan. 23, 2015

(51) Int. Cl. G06F 17/50

(52) U.S. Cl. CPC G06F 17/5054

(57) ABSTRACT

A method and system of instantiating protocol conforming virtual fieldbus devices and models of their associated segment components. The resulting fieldbus virtual segment implements the full protocol stack, and may be interfaced to a host allowing the full characteristics of the segment to be simulated. The interface between host and simulated segment is the native protocol of the host, and each instantiated device implements the appropriate full protocol stack.

### FIELD OF TECHNOLOGY

The invention relates to process control systems, specifically to a simulator that simulates a fieldbus segment and associated devices, and the method whereby the virtual fieldbus devices are instantiated.

### BACKGROUND OF INVENTION

Process control systems used in industry such as pulp and paper, petrochemical, or mining generally consist of a controller that interfaces to field devices via I/O cards or bus interface cards. A typical control system controller node communicates to other controller nodes through the control network (often proprietary protocol on top of Ethernet as the physical layer). Usually the controller interfaces to I/O cards or bus interface cards through a proprietary means (often through a backplane), and finally field devices interface to I/O cards or bus interface cards with whatever industry standard protocol the I/O card or bus interface card implements. In the case of bus interface cards, the card implements that industry standard protocol, and acts as host for the associated segment(s). An important observation that must be made when describing a typical industrial control system is that from the control node to the I/O or bus interface card, the design is usually of a proprietary nature. From the I/O or bus interface card to the field device(s), an industry standard protocol must be adhered to.

The general trend in industry is a move towards bus technology as opposed to conventional hardwired discrete or analog I/O. Bus technology has certain inherent advantages that make it attractive for end users. The main advantages are less wiring is required (simpler electrical design), and the fact that most bus systems allow for advanced device diagnostics.

For all advantages bus technology offers, bus technologies are inherently more complicated than conventional hardwired I/O. This creates challenges with implementation design, and testing. These technologies require more attention to installation design details, and generally the completed design cannot be fully tested until the final installation. These two problems are related, since any issues not noticed by review or inspection at the design stage will generally not be apparent until the final installation is complete. Usually in these industrial settings, design changes or corrections are much more straightforward and less expensive than at final installation. For this reason, a means of testing the complete design would be highly advantageous.

In the industry, there exist commercially available systems for process control simulation, however these systems suffer from two main drawbacks. The first is that these simulators interface to the control system somewhere between the bus interface card and the control network. The physical layer protocol employed is that of the proprietary interface, not of the device being simulated. These simulators are proprietary in nature meaning that the simulation system will not inter-operate between different vendor equipment. The second drawback is related to the first. Commercially available systems do not simulate a protocol compliant device, they instead simulate only a portion of the device, and generally this realized as a model of only the top-most protocol later of the device (usually application layer). An example of such a system is the Mimic system by Myna Technologies. A typical Myna system interfaces to Emerson DeltaV controller via VIM (Virtual Interface Module) on the controller backplane. This system is capable of simulating fieldbus control strategies, however the full protocol stack and the installation details (segment characteristics) of the actual devices are not simulated.

Prior art includes proposed systems and methods that claim to simulate fieldbus devices. These methods have been limited to simulating device characteristics with a device model, and do not instantiate a protocol compliant device. Furthermore, these proposed systems do not simulate the physical layer characteristics, only model the device characteristics and associated dataflow.

### SUMMARY OF INVENTION

The invention concerns a system and method for instantiating protocol conforming virtual fieldbus devices and models of their associated segment components, hereafter referred to as a Segment Simulator. The Segment Simulator system consists of a simulator circuit board containing a physical layer interface, an FPGA implementing a model of the physical layer, and a microprocessor implementing the full fieldbus protocol stack, software to allow instantiating a protocol compliant fieldbus device from either vendor supplied device configuration file(s) such as Device Definition (DD) files in the case of Foundation Fieldbus or HART protocol, or Electronic Data Sheet (EDS) files in the case of DeviceNet, or otherwise appropriate files for the protocol of interest. In addition the above, the Segment Simulator contains a configuration port interfacing to the microprocessor to allow for configuring the device instances, as well as configuring the segment properties such as spur lengths, and characteristic impedance of the cable. This configuration port could be an industry standard port such as Ethernet or USB, allowing the host configurator to be a standard Personal Computer (PC). Alternatively, a Segment Simulator may be realized with an embedded host configurator using any number of protocols as part of a larger control system.

Each fieldbus device on the virtual segment is instantiated as a protocol compliant device. Possible protocols include but are not limited to Foundation Fieldbus, HART, Profibus, and DeviceNet. These devices exist as software instances residing in the simulator microprocessor, and are preferably created from the vendor device configuration files, or alternatively from a user created device template. A collection of vendor device configuration files and/or user created device templates would comprise a library.

To allow for simulation of the fieldbus pysical layer, segment layout information is also downloaded to the Segment Simulator via the configuration port. Segment layout information consists of segment length, fieldbus device placements, spur lengths, and terminator placement. This information is used to build a model of the fieldbus segment which is implemented in the FPGA.

Configuration of the Segment Simulator via the configuration port may be a one time event allowing the Personal Computer used for configuration to be disconnected (temporary connection), or alternatively, the connection could be made permanent to allow re-configuration of the virtual segment at any time.

### BRIEF DESCRIPTION OF DRAWINGS

Embodiments of the invention will be described with references to the following drawing figures. Like items between separate drawing figures are represented with like numerals, and in which:

FIG. 1 is a block diagram of a typical industrial control system

FIG. 2 is a block diagram of an embodiment of the Segment Simulator hardware

FIG. 3 is a block diagram of an embodiment of the Segment Simulator Software

FIG. 4 is a block diagram of an embodiment of the Virtual Fieldbus Device Instantiation process

FIG. 5 is a block diagram of another embodiment of the Virtual Fieldbus Device Instantiation process

FIG. 6 is a block diagram of the host view of an embodiment of the Segment Simulator System

FIG. 7 is a block diagram of an embodiment of the transmission line model

### DETAILED DESCRIPTION

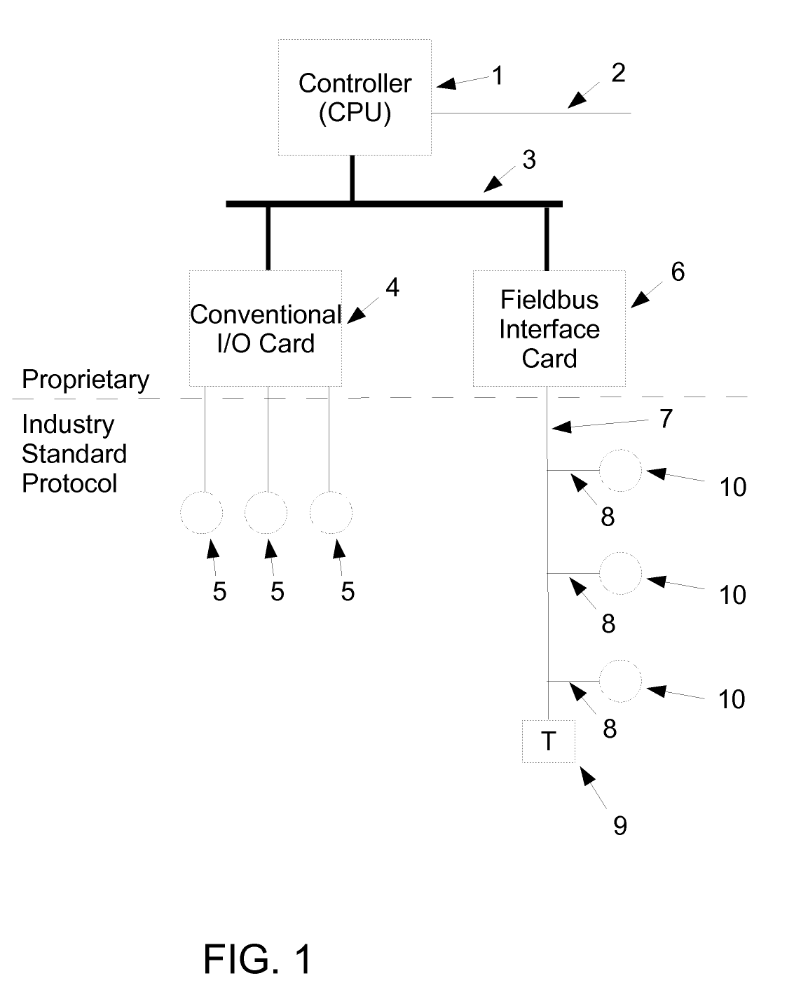

A typical industrial control system is shown in FIG. 1, One or more controllers 1 process the installed system control strategies, and communicate to other peer controllers via the control network 2. Field process variables from and to conventional devices 5 (analog transmitters, switches, analog valves, etc.) and fieldbus devices 10 are communicated from and to the controller by way of conventional I/O cards 4 and Fieldbus interface cards 6 respectively, typicallyvia a backplane 3. Conventional devices 5 are connected to the associated conventional I/O card 4, each by a single dedicated cable. In contrast, multiple fieldbus devices 10 are connected to the associated fieldbus interface card via a segment cable 7, and shorter lengths of cable called spurs 8. Typically, most fieldbus protocols require a terminator 9 to prevent signal reflection at the end of the bus. As shown in FIG. 1, in general, the controller(s) 1, control network 2, backplane 3, conventional I/O cards 4 and fieldbus interface cards 6 are of a proprietary design. Actual field devices 5, 10 and associated fieldbus cabling comprising the segment and spurs 7, 8 and the terminator 9 are all industry standard specified to allow the given protocol to be realized.

The invention implements the industry standard fieldbus protocol of interest, and instantiates in software the fieldbus devices 10. Each fieldbus device instantiated 10 is a fully protocol compliant device implemented in software. Possible protocols include but are not limited to Foundation Fieldbus, DeviceNet, and Profibus. Two possible embodiments (described in detail later) of device instantiation are firstly from vendor provided device definition files (including but not limited to DD files in the case of Foundation Fieldbus, and EDS files in the case of DeviceNet) and secondly from a user defined device template. These user defined device templates would have the same structure and syntax as the vendor provided device definition files, but could be used either to test a subset of a vendor device, or for the user to define alternate devices.

When a device is instantiated 10 from the vendor supplied device definition files, the operation of the instantiated device 10 communication and execution is identical to an actual vendor device, provided the device definition files accurately describe the actual vendor device. Operationally, the only difference between an actual vendor device and the software instantiated device 10 is that the software instantiated device has not physical sensing element, instead the primary sensing element value is replaced by a user accessible parameter to allow for device measurement simulation.

In addition to the instantiated devices 10, the invention incorporates a transmission line model to simulate the full segment 7 behavior. This behavior is affected by the number and spatial placement of fieldbus devices 10 on the segment 7, as well as the length of the spurs 8, and placement of the terminator 9. Components 7, 8, 9 in FIG. 1 and their placement and length comprise the installation details of a given fieldbus, and are characterized using the transmission line model.

The combination of instantiated devices 10 and transmission line model characterization of the segment, spurs, and terminator 7, 8, 9 respectively comprise a full fieldbus segment design simulation. The simulation uses the native fieldbus protocol, and when using vendor provided device definition files, fully implements the actual vendor device communication and execution. From point of view of the fieldbus host (fieldbus interface card) 6, there is no difference between an actual fieldbus installation and the simulated segment provided by the invention.

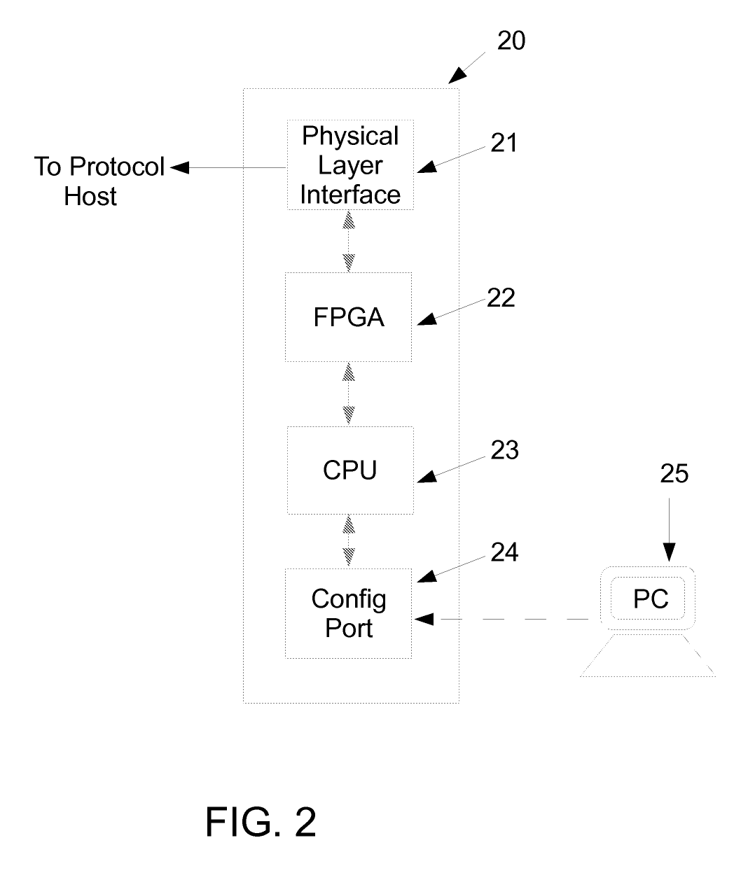

A block diagram of an embodiment of the system hardware is shown in FIG. 2. Data flow is represented by double ended arrows. Circuit board 20, contains a fieldbus physical layer circuit (or Integrated Circuit) 21, an FPGA 22, a microprocessor unit (Central Processing Unit—CPU) 23, and a configuration port 24. The fieldbus physical layer circuit (or Integrated Circuit) 21 converts the fieldbus physical layer electrical signal format and levels to that of the remainder of the circuit in the case of data reception, and vice versa in the case of data transmission. The FPGA 22 implements the physical layer model. This model is based on the well known equations that describe a typical transmission line. At time of configuration, the layout of the fieldbus segment is downloaded to the microprocessor 23. The microprocessor 23 then generates a set of individual transmission lines demarcated by connections to device. or host ports, and spur to segment connections. On transmission of a fieldbus symbol from any node on the fieldbus segment, the FPGA solves the governing equations for each individual transmission line, and calculates the received symbol value at each of the receiving nodes. On a well designed segment with proper termination, each received symbol will match the transmitted symbol. If the design is not proper however, one or more received symbols may be different than the transmitted symbol.

The microprocessor 23 shown in FIG. 2 implements the industry standard protocol software stack, and executes the configured virtual device instances (described in detail later). Configuration of the Segment Simulator is via configuration port 24. This port may be an Ethernet port or USB port allowing a host Personal Computer (PC) 25 to download both the device instances and the segment layout to the microprocessor 23.

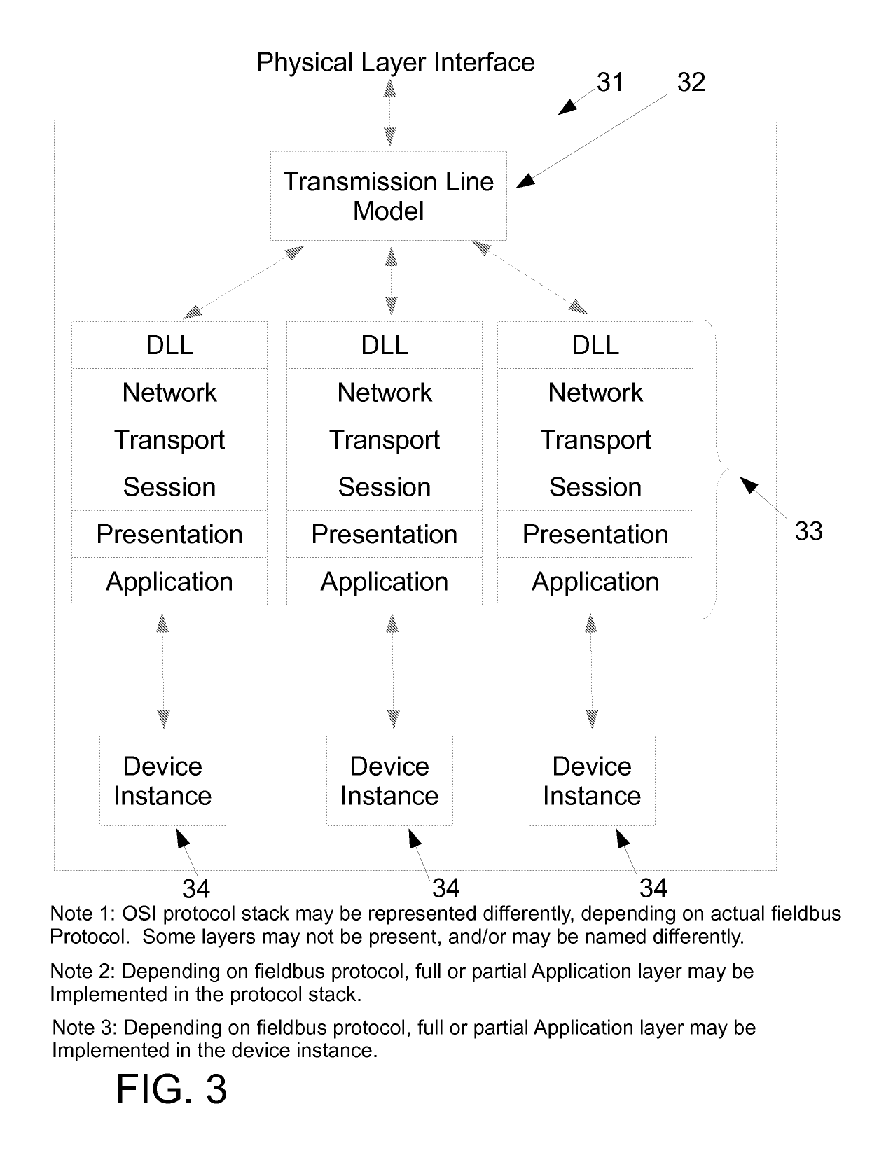

A block diagram of the software is shown in FIG. 3. Data flow between components is represented by double ended arrows. The Segment Simulator software application 31 consists of a transmission line model 32 implemented on the FPGA 22 shown in FIG. 2, a fieldbus protocol software stack conforming to the OSI model 33, and one or more virtual device instances 34. A device instance 34 is a software implementation of an actual device 10 as shown in FIG. 1. Depending on what fieldbus protocol is implemented, the device instance 34 might comprise all or part of the protocol application layer as described by the OSI model. Each device instance 34 is a protocol compliant device, and when instantiated with vendor device configuration files will match the behavior of an actual vendor device.

Communication between device instances and other device instances or the fieldbus host is via a protocol stack 33 instance. This stack is fully specified by the protocol of interest, for example Foundation Fieldbus, Profibus, DeviceNet, or other. Depending on the protocol of interest, the protocol stack layers may be represented differently than the OSI model, however the intent is the same. The specified stack is implemented on the microprocessor 23 of FIG. 2., and one stack instance 33 is created for each device instance.

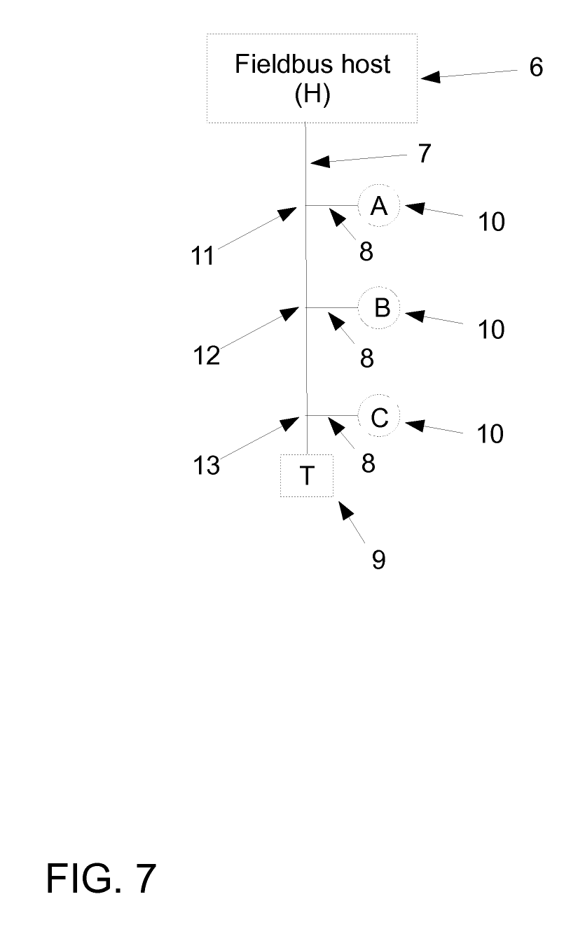

Physical layer simulation is by the transmission line model 32 software component. This component is implemented in the FPGA 22 of FIG. 2. Each demarcated segment or spur length constitutes a single transmission line. Referring to FIG. 7, a fieldbus design implementation is shown which includes fieldbus host (H) 6, the fieldbus segment 7, and fieldbus devices 10 labeled as A, B and C. Each fieldbus device is connected to the segment via spurs 8, with the segment teminated by terminator 9. Also labeled are points 11, 12, 13. These points are those where a spur connects to a segment. In this diagram, the full segment can be demarcated into individual transmission lines host 6 to 11, 11 to A, 11 to 12, 12 to B, 12 to 13, 13 to C, and 13 to 9 terminator. Referring to FIG. 3. when a transmission originates from either a device instance protocol stack or the physical layer interface (host), the transmission line model is executed. This model starts with the transmission line terminating at the transmitting entity, and calculates using the well known Telegrapher's equations the signal voltage level at each extent of each transmission line. Where a transmission line extent coincides with a device 10 or host 6, the voltage level is tested against the specified signal voltage level of the protocol of interest. The resulting symbol is passed to the DLL layer contained in the protocol stack 33 if the coincident transmission line extent is a device instance, or to the physical later interface if the coincident transmission line extent is the fieldbus host.

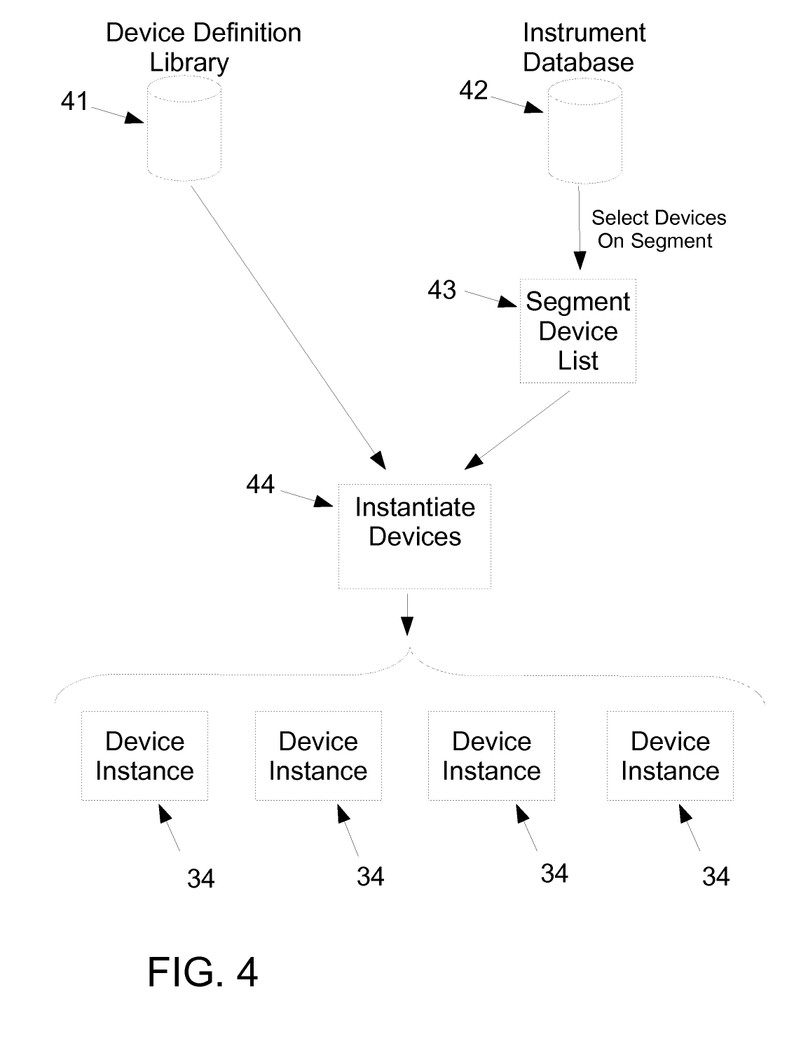

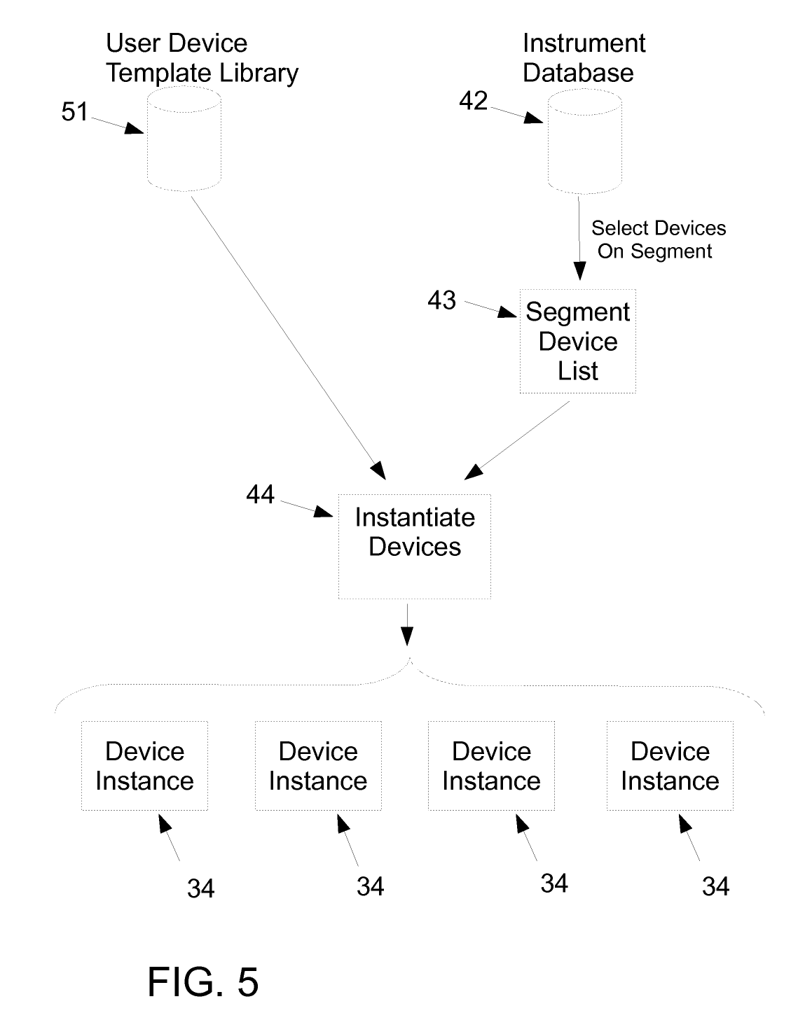

A device instance may be created in several ways. Two such methods are shown diagrammatically in FIG. 4 and FIG. 5. Referring to FIG. 4, a device instance 34 may be created from an instrument database 42 and a device definition library 41. The device definition library consists of the set of vendor device definition files for all devices that exist in the fieldbus segment design. To instantiate all device instances 34 a segment device list 43 is created. This list is a subset of the full instrument database, and could be realized by a Select query from the instrument database 42 having select criteria set to the segment of interest. The device instantiation process 44 is for each device in segment list 43, find the device type specification from the device definition library 41 then instantiate a protocol compliant device 34 based on the vendor provided device type specification from the device definition library 41. The resulting device instances 34 contain all vendor specified objects, since the specification is taken from the vendor device definition files, and will operate identically to an actual vendor device from the host point of view. Referring to FIG. 5, a device instance 34 may be created from a instrument database 42 and a user device template library 51. The device template library consists of a set of definition files for all devices that exist in the fieldbus segment design. These definition files follow the same format and syntax of vendor provided files, however user files could be used to create device instances of new types. To instantiate all device instances 34 a segment device list 43 is created. This list is a subset of the full instrument database, and could be realized by a Select query from the instrument database 42 having select criteria set to the segment of interest. The device instantiation process 44 is for each device in segment list 43, find the device type specification from the device definition library 41 then instantiate a protocol compliant device 34. It is up to the user to ensure that the device template library components are protocol compliant, or else the resulting instantiation may fail or be non protocol complinat.

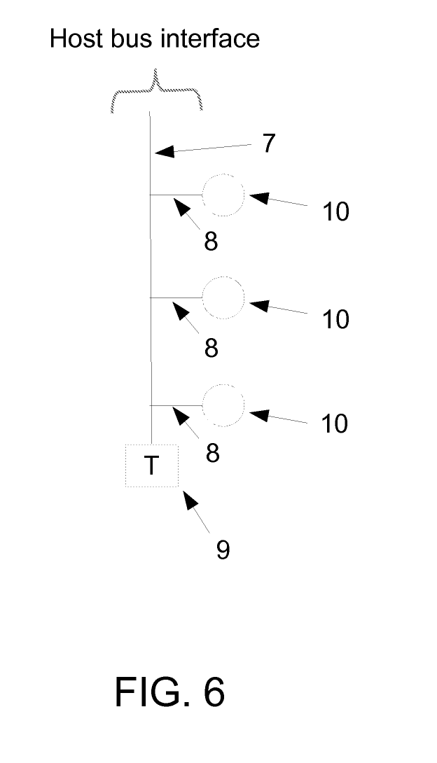

Referring to FIG. 6, when the Segment Simulator is properly configured, the host view will be indistinguishable from that of an actual implementation. The host will operate as if actual devices 10 are connected to the segment. Furthermore, the electrical characteristics of the segment design are simulated such that the length of the segment 7, device 10 placement, spur 8 lengths and terminator 9 placement is incorporated into the overall segment simulation.

1. A method for simulating operation of a full fieldbus segment design containing at least one fieldbus device.

2. The method according to claim 1 whereby each fieldbus device is instantiated as a fully protocol compliant device in software.

3. A method according to claim 2 whereby each fieldbus device is instantiated from vendor provided device definition files.

4. A method according to claim 2 whereby each fieldbus device is instantiated from user created device template files.

5. The method according to claim 1 whereby each fieldbus segment layout is simulated by a physical layer transmission line model.

6. The method according to claim 5 whereby each fieldbus segment is demarcated by devices, host and spur/segment connection into individual transmission lines.

7. The method according to claim 6 whereby each individual transmission line voltage level is calculated on a symbol by symbol basis.

8. The method according to claim 7 whereby each individual node on the segment has symbol calculated on the basis of the signal level specification of the protocol of interest.
